(19) United States
(12) Patent Application Publication
(10) Pub. No.: US 2007/0025272 A1
(43) Pub. Date: Feb. 1, 2007

(54) Reduced order model node location method for multi-hop networks

(76) Inventors: Feng Niu, Weston, FL (US); Spyros Kyperountas, Weston, FL (US); Qicai Shi, Coral Springs, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/194,009

(22) Filed: Jul. 29, 2005

(51) Int. Cl. H04L 12/28

(52) U.S. Cl. 370/254

(57) ABSTRACT

A method for locating nodes in a multi-hop sensor network forms a rigid body (RB1, RB2, RB3) and, from the nodes, utilizes the rigid body to decide if a node is locatable. The method obtains a reduced order model (ROM) of the network by categorizing all of the nodes by location status, grouping them based upon the categorizations, and defining and identifying a rigid body from a group. To locate the nodes, the nodes are separated from one another into subsets dependent upon characteristics (1100). Then, super groups are formed from one subset (1200) and the sub-groups are formed from each super group (1300). The rigid body core is formed (1400) and the resultant rigid body is determined (1500). The ROM is formed from the rigid body (1600) and a location capability of the rigid body is evaluated based upon the ROM (1700).

### RELATED APPLICATIONS

This application is related to pending U.S. application Ser. No. 10/424,178 filed on Apr. 25, 2003, commonly assigned to Motorola, Inc.

### BACKGROUND OF THE INVENTION

1. Field of the Invention

This invention relates in general to rigid body based location and more particularly to a method for discovering rigid bodies in a wireless network.

2. Description of the Related Art

In a multi-hop sensor network, because of limited transmitted power, a communications node can only communicate with a small subset of the other communications nodes in the entire network. A traditional location system may not work for a multi-hop network because the multi-hop network requires that any node be linked directly to three reference nodes with known locations that are not on a line in a two-dimensional space or to four reference nodes with known locations that are not on a plane in a three-dimensional space. The consequence of such failure is that many nodes will not be able to locate, especially when the sensor network is sparse.

An iterative or successive procedure is used to change a node to an induced reference node if the node can be located using the traditional approach. Thus, induced reference nodes are nodes that initially do not know their coordinates but, because they have the range measurements from a sufficient number of nodes with known coordinates, they can solve a simple triangulation problem and discover their own coordinates. See “Recursive Position Estimation in Sensor Networks,” Joe Albowicz, Alvin Chen, and Lixia Zhang, UCLA Research Laboratory, 2001. However, after such a procedure, there will still be a subset of the nodes that is not located, especially in a sparse sensor environment. Moreover, existing methods that decide if a node is locatable or not do so by establishing the number of independent paths of each node to reference nodes, which becomes highly computationally intense for large networks. This method can also be shown to result in erroneous decisions as far as position solutions are concerned.

Thus, there is a need to formulate a simplified process to discover the rigid body in a wireless network as well as generic rules to determine the locatability of the rigid body. This will allow the location of any node in a wireless peer-to-peer location network to be determined.

### SUMMARY OF THE INVENTION

In accordance with the present invention, there is provided herein a reduced order model (ROM) location method for multi-hop networks with some peer-to-peer capability that overcomes disadvantages of the prior art systems and methods of this general type and that provides new location measures using the rigid body concept. The invention reduces the degree of the freedom in the system to arrive at a reduced order model and applies a procedure to obtain the reduced order model with innovations that include a coloring scheme for initial categorization of nodes, a method to group the nodes into super groups, a method to group the nodes into sub-groups, a new independent path procedure, and defining and identifying rigid body(ies) with joint node(s).

With the foregoing and other objects in view, in accordance with the invention, a method for locating nodes in a multi-hop sensor network forms a rigid body from the nodes and utilizes the rigid body to decide if a node is locatable. The method obtains a reduced order model of the network by categorizing all of the nodes by location status, grouping them based upon the categorizations, and defining and identifying a rigid body from a group. The method further simplifies determinability of node location by forming the rigid body from the nodes based upon the categorized location status. To locate the nodes, the nodes are separated from one another into subsets dependent upon characteristics. Then, groups are formed from one subset and rigid bodies are formed from a group. The ROM is formed from the rigid bodies and a locatability of the rigid bodies is evaluated based upon the ROM. As used herein, the phrase “rigid body” means that the spatial or geometrical relationships between a set of nodes are fixed by the given peer-to-peer distances among them. In other words, these nodes form a geometrically rigid or non-deformable “shape” or “structure” due to the given distances between them. The phrase “locatability” means the probability of having a unique location solution.

The method of the present invention overcomes the problems associated with the prior art by an innovation in categorizing the location status of all nodes in a multi-hop network. Such innovation includes the formation of rigid bodies from these nodes through different levels of grouping processes and, thus, simplifies the problem of locating the nodes that cannot be located (nodes without enough of a number of direct links to the reference nodes) through the traditional methods. The present invention is a reduced order modeling of the distributed sensor network, which modeling decides whether each node is locatable, the order of location for minimum propagation error throughout the network, and the algorithms that should be employed to achieve best location.

The location system is based on the reduction of the network search space within every step leading to solid structures in space, in other words, the rigid bodies. This not only allows for an efficient algorithm for location estimation but also provides a global perspective of the network's ability to locate (in parts or as a whole) with all the inherit advantages. This will enable the resolution of optimum location strategies for any sensor node deployment.

Other features that are considered as characteristic for the invention are set forth in the appended claims.

Although the method is illustrated and described herein as embodied in a reduced order model location method for multi-hop networks, it is, nevertheless, not intended to be limited to the details shown because various modifications and structural changes may be made therein without departing from the spirit of the invention and within the scope and range of equivalents of the claims.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 is a flow chart of the method according to the invention;

FIG. 2 is a diagrammatic illustration of a group of nodes according to the invention;

FIG. 3 is a diagrammatic illustration of a rigid body core of nodes according to the invention;

FIG. 4 is a diagrammatic illustration of a rigid body of nodes according to the invention;

FIG. 5 is a diagrammatic illustration of two rigid bodies connected by a single node;

FIG. 6 is a diagrammatic illustration of a group of nodes that cannot be identified as not locatable according to the prior art and can be identified according to the invention;

FIG. 7 is a diagrammatic illustration of a group of nodes not locatable according to the prior art and locatable according to the invention;

FIG. 8 is a diagrammatic illustration of an exemplary initial deployment of nodes to be located;

FIG. 9 is a diagrammatic illustration of a first association of the nodes of FIG. 8 after a partial execution step according to the invention;

FIG. 10 is a diagrammatic illustration of a second association of the nodes of FIG. 8 after another partial execution step according to the invention;

FIG. 11 is a diagrammatic illustration of a third association of the nodes of FIG. 8 after a further execution step according to the invention;

FIG. 12 is a diagrammatic illustration of a final association of the nodes of FIG. 8 after execution of the steps according to the invention;

FIG. 13 is a flow chart diagram showing an alternative embodiment of the invention showing a method by grouping nodes into super groups and sub-groups within the super group;

FIG. 14 is a diagrammatic illustration of two rigid bodies where a two-dimensional grouping procedure is used for three-dimensional space;

FIG. 15 is a diagrammatic illustration as that in FIG. 14 where one rigid body is actually two rigid bodies where the four links between them are not rigid;

FIG. 16 is a diagrammatic illustration of a rigid body core of nodes according to the invention; and

FIG. 17 is a diagrammatic illustration of a rigid body core of nodes according to the invention.

### DESCRIPTION OF THE PREFERRED EMBODIMENTS

While the specification concludes with claims defining the features of the invention that are regarded as novel, it is believed that the invention will be better understood from a consideration of the following description in conjunction with the drawing figures, in which like reference numerals are carried forward.

The present invention forms rigid bodies from the nodes of a distributed sensor network utilizing a Reduced Order Modeling (ROM) of the network. To carry out the modeling, decisions on the locatability of each node, on the order of location for minimum propagation error throughout the network, and on the algorithms that should be employed to achieve best location are made.

To more efficiently locate nodes in a distributed sensor network, an efficient algorithm is needed for location discovery. To arrive at a decreased space, subsets of nodes can be defined so long as the subsets have a sufficient degree of confidence for locating at least a few of the nodes in each subset. If these subsets, also referred to herein as “rigid bodies,” can be located only upon an even smaller subset of nodes contained therein, then location efficiency increases. By defining rigid bodies made up of a plurality of nodes according to a particular system, it is possible to locate every node forming the rigid body if only four (three or two) nodes of the rigid body in the three (two or one) dimensional space are locatable. Therefore, the location system of the present invention is based on a reduction of the network search space within every step leading to the rigid bodies, in other words, solid structures in space.

Therefore, the system of the present invention is directed towards finding and identifying the rigid body(ies) within the distributed sensor network. According to the present invention, a unique location of each node is ascertained, in other words, there is an inquiry and a determination as to the ability of a node to be locatable or not locatable. Efficiency increases if the process only spends time on attempting to locate the nodes determined to be locatable and eliminating, as early as possible, the non-locatable nodes from further investigation.

The system described below relates to a two-dimensional scenario. However, the same principles apply for a three-dimensional setting with some modifications as described later in the alternative embodiment. The location system can be described by a five-step procedure set forth in general in FIG. 1 and with greater detail in the following text.

Initially, it is assumed that the peer-to-peer ranging information of each sensor (i.e., node) throughout the network is available.

Step 100: Coloring System Node Categorization

Nodes are separated from one another into different groups dependent upon particular characteristics. These groups are, herein, given color descriptions including green, red, and blue.

Green nodes are those nodes that are linked to at least three other green nodes and/or reference nodes not on the same geometric line. Green nodes are the nodes (induced reference nodes) that can be progressively located from reference nodes and have one positioning solution. They are the most “trusted” nodes in the network and should be located first.

Red nodes are those nodes that are linked to only one or two other nodes not including the red nodes. Red nodes are, specifically, the nodes having more than one solution to their respective location and should be treated accordingly.

Finally, the remaining nodes are defined as blue nodes. Blue nodes are those nodes for which there is still an uncertainty as to whether or not they can be located in this Step 100.

Step 200: Formation of Groups to Include all Blue Nodes

A group forming process starts with a blue node and its neighboring blue or green node (preferably blue). These two nodes, together, form a seed pair for a given group. To grow the group, the following rule is used: any blue or green node connecting to two nodes within the group becomes part of the group. The process ends when all the nodes that can be added to this given group are added. Once the process ends, the given group is formed. This process is repeated until all possible groups are formed in the network

Step 200 is illustrated by the example shown in FIG. 2. The initial node pair is formed with nodes 1 and 2. Then, because node 3 has two links to the initial node pair, node 3 joins the group. Nodes 4 and 5 are joined to the group in a similar manner. A new group forming process starts with a blue node that is not included in any one of the previously defined groups. The process described above is repeated and continues until no blue nodes are left.

The groups are further trimmed down to define:
edge nodes (EN)—nodes that are linked to only two nodes in a given group;
a non-trivial group core (NTGC)—groups having more than three nodes after removing the edge nodes; and
trivial groups—triangles and linked node pairs.

The resulting groups are either rigid or a collection of rigid bodies.

Step 300: Formation of Rigid Bodies

This is a two-step process that initiates in each NTGC as follows:

a) Starting with a triangle (also referred to as an initial core or basic rigid body) within a NTGC, a node is added to the initial core if the node is linked (through a single communications hop) to at least three nodes in the progressively forming core. Such progressive linking results in the definition of a rigid body core (RBC). The first part of this two-step process enrolls most of the nodes that are part of the rigid body.

An example of this sub-step a) is illustrated with regard to FIG. 3. Specifically, an initial triangle is formed with nodes 1, 2, and 3. Node 4 joins the RBC because it has 3 links to the initial core, specifically, it has a one-hop link to each of nodes 1, 2, and 3. Finally, node 5 joins the RBC because it has 3 links thereto, specifically, it has a one-hop link to each of nodes 1, 2, and 4.

b) An RBC in a group is expanded to form a rigid body. The rigid body is formed by including a node having three independent paths to three nodes already in the RBC. The rigid body is further expanded by examining each node connected by one hop to the rigid body and including all nodes examined to have three independent paths to three nodes already in the rigid body.

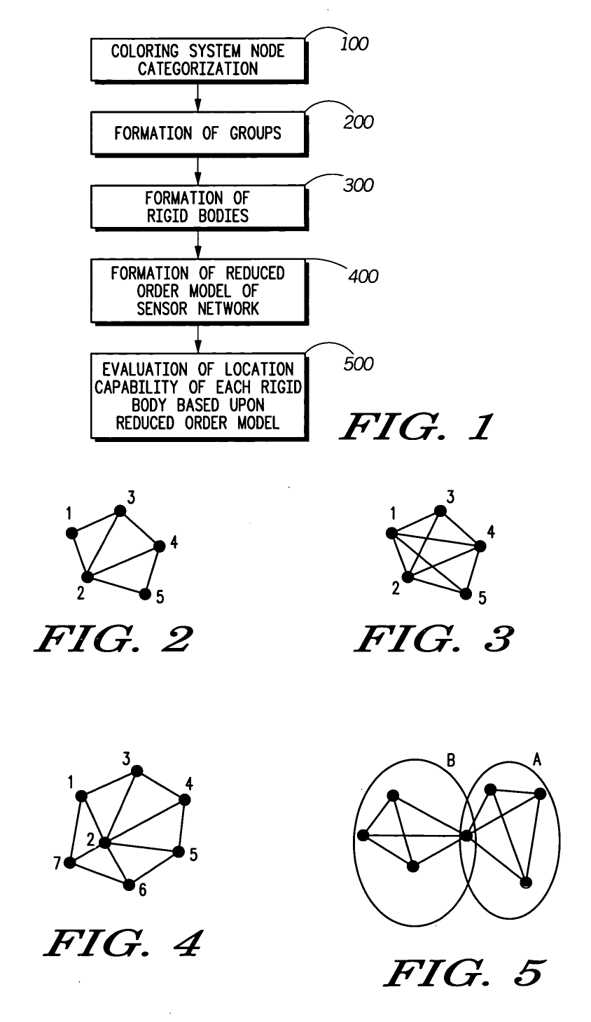

FIG. 4 illustrates a rigid body formed by the process of this sub-step b). As before, the initial triangle is formed with nodes 1, 2, and 3. Clearly, no other node has three links to the initial triangle, but node 4 can join the initial core triangle because there are three independent paths from node 4 to the different nodes of the initial triangle. Specifically, there is a direct link between node 4 and node 3, there is a direct link between node 4 and node 2, and there is an independent (albeit indirect) link from node 4 to node 1 through nodes 5, 6, and 7. In a similar fashion, nodes 6 and 7 can join the rigid body formed by nodes 1 through 4.

If three nodes in an RBC also belong to another RBC, the two RBCs are merged into one rigid body. These rigid bodies continue to expand until all nodes are absorbed and all RBCs are either absorbed into rigid bodies or become rigid bodies themselves. By the end of this Step 300, every blue node is either part of a rigid body in a group or is defined as an edge node.

The independent paths are defined as paths with no common nodes rather than no common edges (the traditional way). Such a definition will avoid decisions such as a rigid body A and a rigid body B forming a bigger rigid body when, in fact, they do not. Such a condition is illustrated, for example, in FIG. 5.

Step 400: Formation of the Reduced Order Model of the Sensor Network

Now, all of the blue nodes in the network are assigned as being either a part of a rigid body or as an edge node. Based upon the characteristics of rigid bodies as defined herein, the entirety of each rigid body can be located if only three of its member nodes not in a geometric line are located. From this, the previously complex problem of locating each and every one of the blue nodes is simplified into two much simpler problems:

a) locating only the rigid bodies (much less degrees of freedom, i.e., need only to locate three points on the rigid body per rigid body) and the edge nodes; and

b) locating the member nodes within each rigid body once the rigid body is located (a determination that can be made by locating three of its member nodes not in a geometric line).

Step 500: Evaluation of Location Capability of Each Rigid Body Based Upon the Reduced Order Model

An example of simple rules for deciding whether a body is locatable in two dimensions includes:

a) If a rigid body has three or more reference and/or induced reference nodes, every node on that rigid body is located;

b) If a rigid body has two reference/induced reference nodes and at least one other node (not in one geometric line with the two reference/induced reference nodes) linked to at least one reference/induced reference node, every node on the rigid body is located;

c) If a rigid body has one reference/induced reference node or an edge node that is a reference/induced reference node and also has at least two other nodes (not in one geometric line) linked to at least two other reference/induced reference nodes, every node on the rigid body is located;

d) If a rigid body has no reference/induced reference nodes but at least three other nodes (not in one geometric line) linked to at least three reference/induced reference nodes, one of which having at least two links to the rigid body, every node on the rigid body is located; and

e) If a rigid body is located, any edge node of that rigid body is also located if the particular edge node is linked to a reference/induced reference node or another located rigid body.

Traditional methods define a node to be locatable if it has three independent paths to reference nodes. These methods disregard the global picture of the network and often result in erroneous decisions with respect to positioning. Simply put, rotating a dot on a map results in no change until one observes that the dot is part of a bigger body and the rotation will affect a positioning of the total system of which the dot is one part.

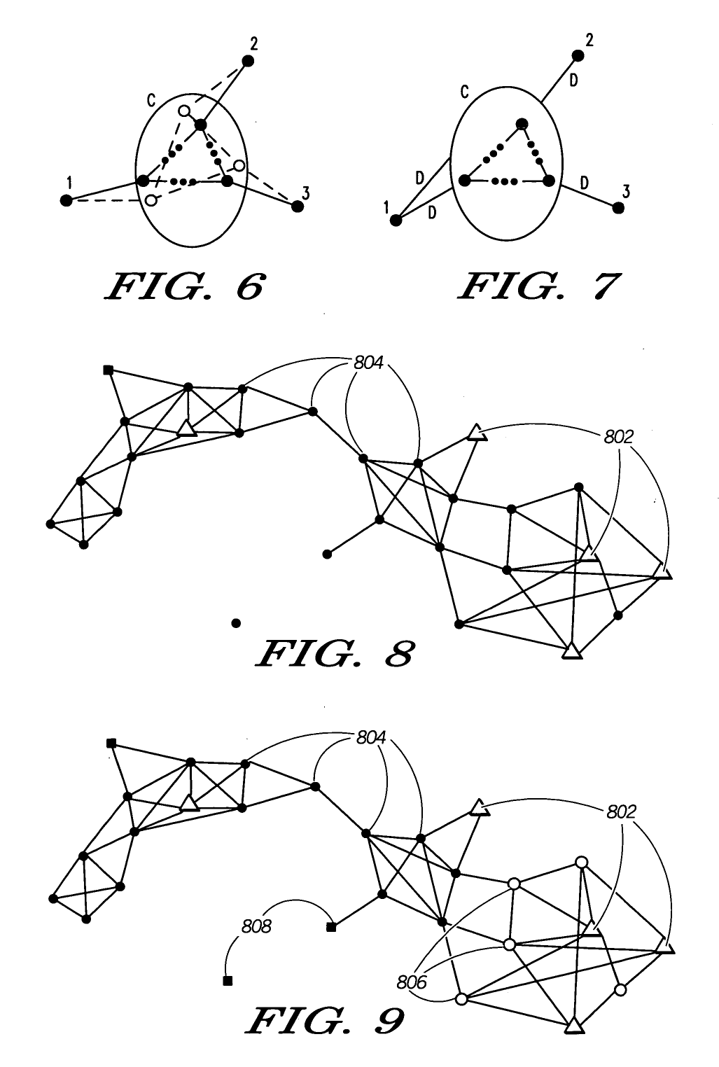

To illustrate this point, the following example is explained with regard to FIG. 6. Using the traditional node rule, the nodes within rigid body C will all be determined as locatable because all have independent paths to reference nodes 1, 2, 3. However, they are not locatable. Actually, the three nodes within rigid body C have two discrete positioning solutions. The first solution is illustrated with black nodes and the second solution is illustrated with white nodes—one of these sets of nodes being a rotated version of the other of these sets of nodes. Through the rigid body Reduced Order Model of the present invention and rule d) in Step 500 above, such a situation is identified in addition to the solution for successful positioning because, shown in FIG. 7, at least three other nodes 1, 2, 3 (not in one geometric line) are linked D to at least three reference/induced reference nodes (the three nodes within rigid body C), one of the other nodes 1 having at least two links D to the rigid body.

The following text sets forth an example multi-hop sensor network and applies the algorithm of the present invention to the network. As will be shown, the algorithm easily identifies the rigid bodies and distinguishes locatable rigid bodies from non-locatable rigid bodies.

In the example simulation illustrated first in FIG. 8, a sample rectangular observation space is selected (the shape is chosen merely for illustration purposes). Nodes are randomly positioned in the space of FIG. 8 (28 in the example), 5 of the nodes being reference nodes 802 (indicated with triangles) and the remaining nodes 804 to be evaluated for location capability (indicated with circles). It is assumed, in this example, that each node has an average communication distance that extends approximately one-fifth of the total horizontal distance and approximately one-fifth of the total vertical distance. Thus, lines between two nodes respectively indicate that the two nodes connected by the line are within each other's communications range.

FIG. 9 illustrates the results after executing Step 100. Specifically, each node that is linked to at least three other green nodes or reference nodes 802 is deemed to be a green node. The red nodes 808, also referred to as “lost nodes,” are defined as those nodes that are linked to only one or two other nodes not including other red nodes. Remaining nodes are each defined as a blue node. In FIG. 9, the larger dots (green) illustrate the induced reference nodes 806 and the squares (red) illustrate the nodes 808 that are lost or have either two discrete or circle path solutions with respect to their neighboring nodes.

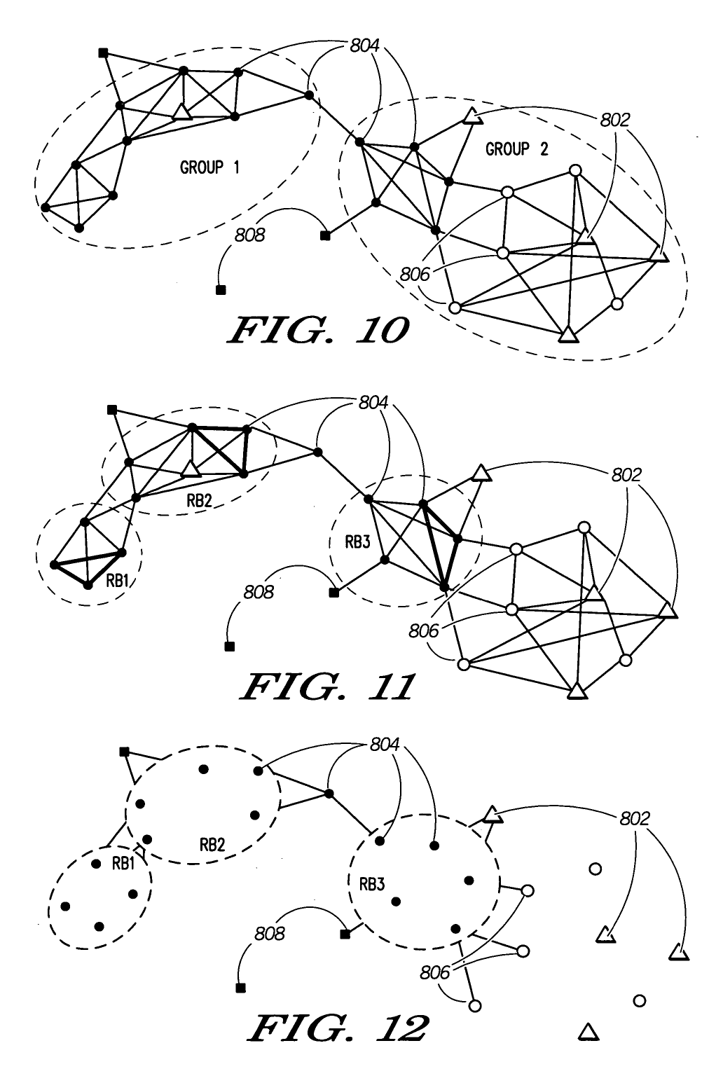

FIG. 10 illustrates the results after executing Step 200. Specifically, seed pairs are formed by a respective blue node and its neighboring blue or green node. Then, the groups are grown by adding to a respective group any blue or green node connecting to two nodes within the respective group. The result of Step 200 splits the network into two groups.

FIG. 11 illustrates the result of performing Step 300. Initial cores of three nodes are found. In the example, three initial cores are selected and are indicated with heavy lines. Starting with these initial cores, nodes are added to each. After adding all possible nodes pursuant to Step 300, three initial cores result in three rigid bodies RB1, RB2, RB3.

FIG. 12 portrays the final Reduced Order Model resulting from Step 400. Simply put, FIG. 12 shows the resulting rigid bodies (RB1, RB2, RB3) and their connection (i.e., solid lines) to any outside network elements (other rigid bodies and nodes).

Then, the rules of Step 500 are applied to decide on the possibility of location of the rigid bodies. In essence, for location error minimization, each identified rigid body that can be located is individually positioned on a respective local coordinate system (because they are very stable structures as far as the ranging error is concerned) without considering any nodes outside that rigid body.

Such effort positions the rigid body's coordinate system within the global coordinate system (in other words, the coordinate system of the green nodes). From FIG. 12 and the rules of Step 500, the system of the present invention easily identifies that RB3 is locatable (because it satisfies rule d)) but RB1 and RB2 are not (because RB1 does not satisfy rule d) or any other rule and RB2 does not satisfy rule c) or any other rule).

Nonetheless, local positioning information can be extracted for RB1 and RB2 if some positioning information is of value (for example, even though RB1 and RB2 are not uniquely located, they may have a specific set of identifiable locations in which they may reside). The system according to the present invention can be applied to any distributed sensor network with ranging capabilities. Similar steps (i.e., coloring and different levels of grouping) and analogous locatability rules (somewhat similar to those in Step 500) can be used for rigid body discovery in three-dimensional networks.

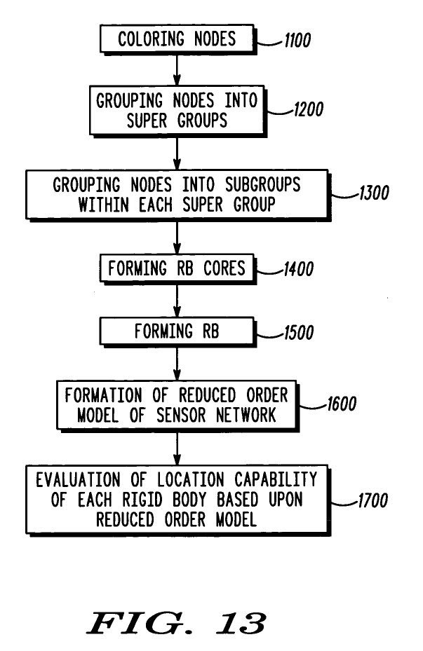

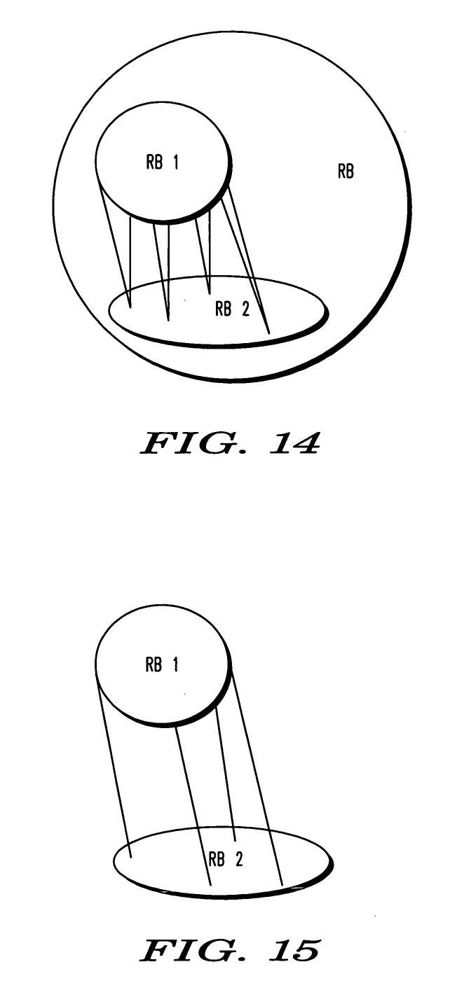

FIG. 13 shows yet an alternative embodiment of the invention utilizing a method for reduced order modeling for determining node location in a multi-hop communications network. This alternative embodiment will reduce to the previous embodiment when applied to systems in the two and one dimensional spaces. The system described below relates to a three dimensional scenario.

Step 1100: Coloring System Node Categorization

With regard to coloring system nodes for categorization, these steps are similar for one-dimensional, two-dimensional and three-dimensional spaces. Accordingly, as noted with the previous embodiment, each of the nodes is separated from one another into different groups depending upon particular characteristics. These groups are, herein, given color descriptions including green, red, and blue. In order to properly form the rigid bodies, this embodiment differs from that described above in that groups have two levels, namely, super groups and then sub-groups within each super group. Assuming that the peer-to-peer ranging information of each node throughout the network is available, then a first node categorization is done using the coloring of the nodes as follows:

a) Green nodes: each of these nodes is linked to at least four other green nodes and/or reference nodes not in the same plane. These are the nodes, such as induced reference nodes, that can be progressively located from reference nodes and have one positioning solution. They are the most “trusted” nodes in the network and should be those that are initially located.

b) Red nodes: each of these nodes is linked up to three other nodes not counting the red nodes. These nodes are essentially those which have more than one solution to their location and should be treated accordingly. Once the red nodes are identified, they are removed along with their links during the rigid body discovery procedure;

c) Blue nodes: the nodes include the remainder of the nodes where it is unclear whether they can be located or not in this the colorizing step 1100.

It should be evident to those skilled in the art that the coloring process will be reiterated on the remaining blue nodes until there is no change in the color status of any blue node in the network. This enables the progressive classification of induced references nodes and progressive elimination of the red nodes. Moreover, locatability in this step can be done in parallel as green nodes are identified. The more iterations needed for a node to become green (induced reference) indicate the accuracy to be expected of this node in its estimated coordinates. This information can be used advantageously in the location discovery process.

Step 1200: Grouping Nodes into Super Groups

Super groups are formed to include all blue nodes. A super group forming process starts with a blue node and its neighboring blue or green node. This is the seed pair for the group. To grow the super group, the following rules are used:

a) Any blue or green node connecting to at least two nodes in or having at least two links to the super group becomes part of the super group. The process ends when all the nodes that can be added in this specific super group are added. Once this process ends, a super group is formed. This can be visualized in FIG. 2 that illustrates a top view of the three-dimensional space. The initial node pair was formed with nodes 1 and 2. Then node 3 joined the group since it has two links to the group, followed by node 4 and node 5. A new super group forming process starts with a blue node not included in the previous super groups. This process as described herein continues until no blue nodes remain.

b) Subsequently, any super group with only two or three or four nodes is categorized as a trivial super group and not considered for the remaining steps; and

c) Each remaining super group is further reduced to edge nodes (nodes linked to only two nodes in their super group) and a non-trivial super group core (NTSGC) which is a super group with more than three nodes after eliminating the edge nodes, or edge nodes and linked node pairs; and

The rule or step (c) is repeated for each super group until there is no more change in each super group. Thus, the resulting super groups are a collection of trivial super groups, NTSGC0s, edge nodes and linked node pairs.

A trivial super group can be a rigid body if it has four nodes not in the same plane or three nodes not in the same line or just two nodes.

Step 1300—Grouping Nodes into Sub-Groups within Each Super Group.

Subgroups are formed to include all the blue nodes within a non-trivial super group core (NTSGC) as noted in Step 1200. A sub-group forming process begins with a triangle to form a seed group. The seed group contains the blue and/or green nodes that all belong to the same NTSGC. To grow the sub-group, the following rules are used:

a) Any blue or green node in the same NTSGC as the seed group and connected to at least three nodes in the seed group becomes part of the seed group. This process ends when all the nodes that can be added to this specific sub-group are added. Once this process ends, a sub-group is formed. The formation of a sub-group is shown in FIG. 3, where the initial triangle seed group is formed with node 1, node 2 and node 3. Node 4 is then joined to the sub-group for having three links to the seed group, followed by node 5. A new seed group forming process starts with a blue node that had not been included in the previous sub-groups. The process continues until no blue nodes remain in any super group.

b) Any sub-group with only 3 or 4 nodes is categorized as a trivial sub-group and is not considered for the remaining steps.

c) The sub-groups are further reduced to sub-group edge nodes (nodes linked to only three nodes in their sub-group), a non-trivial sub-group core (NTSGC) which consists of all the nodes in this sub-group after eliminating the sub-group edge nodes and triangles; and

The rule (c) is repeated for each sub-group until there is no more change in each sub-group. As will be evident by those skilled in the art, the resulting sub-groups are a collection of trivial sub-groups, NTSGCs, sub-group edge nodes and triangles.

A trivial sub-group can be a rigid body if it has four nodes not in the same plane or three nodes not in the same line.

The step 1300 is similar to the step 200 in the first embodiment. This is evident if the two-dimensional terms in the step 200 such as the linked node pair are substituted by three-dimensional terms such as a triangle.

The step 1200 is a new step and becomes a trivial step for one- and two-dimensional systems. This is because a linked node pair in three-dimensional space becomes a node in two-dimensional space and nothing in one-dimensional space. Similarly, two links in three-dimensional systems becomes one link in two-dimensional systems and zero link in one-dimensional systems. If one substitutes these equivalent terms for one- or two-dimensional systems in the rules of the step 1200 to form the super groups, there will be simply one resulting super group including all the nodes in a one-dimensional system or all the communicating nodes in a two-dimensional system.

However, without the step 1200, the discovery of the rigid body in three-dimensional systems will be fragmented. As seen in an example given in FIG. 14, a single rigid body RB will be identified as two separate rigid bodies (RB1 and RB2) in this particular example or multiple rigid bodies in other cases if only the grouping step 1300 is used without the grouping step 1200 before it. But if the grouping step 1200 is the only grouping step used without being followed by the grouping step 1300 one rigid body may be discovered which in reality are two rigid bodies such as that shown in FIG. 15. In this case, the two rigid bodies with four links between them are not rigid. Thus, the invention generalizes the two-dimensional grouping procedure for three dimensions and forms a two-level group structure (super groups and sub-groups). The new procedure applies as well to the one- and two-dimensional systems.

Step 1400—Forming the Rigid Body Core

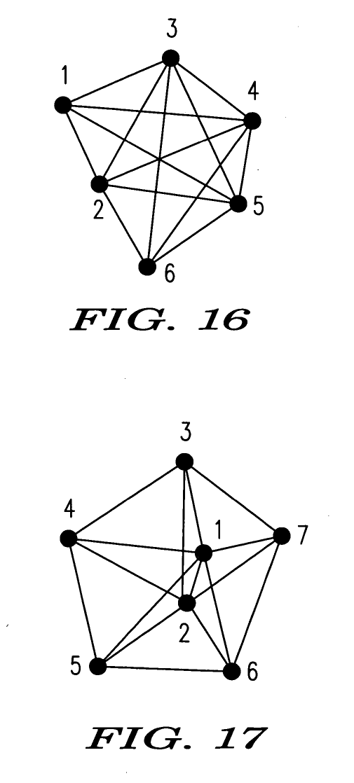

An initial core is a tetrahedral in a NTSGC and a node is added to the core if it belongs to the same NTSGC as the core and is linked by one hop to at least four nodes in the progressively formed rigid body. This results in a rigid body core (RBC). This process will enroll most of the nodes that are part of the rigid body. FIG. 16 illustrates an example of this. The initial tetrahedral is formed with node 1, node 2, node 3 and node 4. Node 5 then joins the rigid body since it has four links to the initial rigid body followed by node 6.

Step 1500—The Formed Rigid Body

Expanding a rigid body core to a rigid body in a group will occur under the following conditions:

If a node has four independent paths (paths with no common nodes) to 4 nodes in a rigid body core, this rigid body core can be expanded to a rigid body to include this node. As seen in FIG. 17, a rigid body is illustrated where the initial tetrahedral is formed using node 1, node 2, node 3 and node 4. Since no other node has four lines to this structure, node 5 can join the rigid body since it has four independent paths to it. These independent paths include the direct link to node 1, node 2 and node 4 and the link to node 3 through node 6 and node 7. Similarly, node 6 and node 7 can join the rigid body. If four nodes in the rigid body core also belong to another rigid body core, the two rigid body cores are merged into one rigid body. These rigid bodies continue to expand until all the nodes are absorbed and all the rigid body cores are either absorbed into rigid bodies or become rigid bodies themselves. Finally, every blue node is either a part of a rigid body, in a trivial sub-group or an edge node.

As noted in FIG. 1, the formation of the reduced order model (ROM) of the sensor network 1600 and the evaluation of location capability of each rigid body 1700 based upon reduced order model is similar to that already described herein.

Rigid Body Locatability Rules

Those skilled in the art will also recognize the present method utilizes rigid body locatability rules for one-, two- and three-dimensional systems. In the following, the term “reference nodes” is used for any nodes with knowledge of its location, regardless how the knowledge is gained. In other words, we do not make a distinction between the reference nodes and the induced reference nodes. The term “blind node” is used for any nodes without knowledge of their location at the time of evaluation.

1. In one-dimensional (1-D) system the rules regarding locatability are:

1a) A blind node is locatable if it is linked to at least 2 reference nodes not at the same point.
1b) A rigid body is locatable if at least 2 blind nodes in the rigid body are linked to at least 2 reference nodes not at the same point.
   2. In two-dimensional (2-D) systems, the rules regarding locatability of a node are:
2a) A blind node is locatable if it has links to at least 3 reference nodes not positioned within a line.
2b) A blind node is locatable with a probability of 1 if it has links to at least 3 reference nodes.

Those skilled in the art will further recognize that although rules 2a) and 2b) are correct, rule 2b) is easier to implement since there is no need to determine whether the three reference nodes are positioned on the same line. The probability of having three reference nodes on the same line is zero since a line occupies zero area in two-dimensional space.

The locatability rule for a linked pair is as follows:
2c) A linked pair is locatable if it has at least 4 links to at least 3 reference nodes not in a line.
2d) A linked pair is locatable with probability of 1 if it has at least 4 links to at least 3 reference nodes.

The locatability of a rigid body in two-dimensional systems can be represented by a minimum of three nodes in the rigid body that are not in a line and utilize the following rules:
2e) A rigid body is locatable if it contains at least 3 reference nodes not in the same line.
2f) A rigid body is locatable with probability of 1 if it contains at least 3 reference nodes.
2g) A rigid body is locatable if it contains 2 reference nodes and there is at least 1 link between at least 1 other reference node not in line with the 1 reference node in the rigid body and at least 1 blind node not in line with the 2 reference nodes in the rigid body.
2h) The rigid body is locatable with probability of 1 if it contains 2 reference nodes and there is at least 1 reference node other than the 2 reference nodes in the rigid body with at least 1 link to at least 1 blind node in the rigid body.

Note that a reference node is contained in a rigid body either through the rigid body discovery process or because it has at least 3 links to the rigid body, and that a blind node in a rigid body becomes a reference node if it is linked directly to at least 3 reference nodes.
2i) A rigid body is locatable if it contains 1 reference node and there are at least 2 other reference nodes not in line with the reference node in the rigid body with at least 2 links to at least 2 blind nodes not in line with the reference node in the rigid body.
2j) A rigid body is locatable with probability of 1 if it contains 1 reference node and there are at least 2 reference nodes other than the reference node in the rigid body with at least 2 links to at least 2 blind nodes in the rigid body.
   When a rigid body does not contain any reference nodes, the following locatability rules apply:
2k) The necessary condition for a rigid body to be locatable is:

there are at least 3 reference nodes with at least 4 links to at least 3 blind nodes in the rigid body.
2l) (sufficient condition): A rigid body is locatable with probability of 1 if there are at least 3 reference nodes with at least 4 links to at least 3 blind nodes in the rigid body and the sum of the numbers of reference nodes, blind nodes and links is at least 11.
2m) (special case): A rigid body is locatable with probability of 1 if there are 3 reference nodes with 4 links to 3 blind nodes in the rigid body and the 2 blind nodes with only 1 link are not linked to the same reference node.
   3. In three-dimensional (3-D) systems, the rules regarding locatability are:
3.1a) A blind node is locatable if it has links to at least 4 reference nodes not in a plane.
3.1b) A blind node is locatable with probability of 1 if it has links to at least 4 reference nodes.
   Those skilled in the art will recognize that both rules are correct, however, rule 3.1b is less difficult to implement since no determination is necessary whether or not the 4 reference nodes are on the same plane.
3.2a) A linked pair is locatable if it has 6 links to at least 4 reference nodes not in a plane.
3.2b) A linked pair is locatable with probability of 1 if it has 6 links to at least 4 reference nodes
3.3a) A triangle, i.e., 3 linked nodes not in a line, is locatable if each of 3 blind nodes in the triangle is linked directly to at least 2 reference nodes and there are at least 7 total links to at least 4 reference nodes not in the same plane.
3.3b) A triangle, i.e., 3 linked nodes not in a line, is locatable with probability of 1 if each of 3 blind nodes in the triangle is linked to at least 2 reference nodes and there are at least 7 total links to at least 4 reference nodes.
3.4a) The necessary condition for a rigid body containing no reference nodes to be locatable: there are at least 4 reference nodes with at least 7 links to at least 4 blind nodes in the rigid body.
3.4b) A rigid body containing no reference nodes is locatable with a probability of 1 if the rule 3.4a) is satisfied; and one of the following conditions is also satisfied:
6 or more blind nodes with each node linked directly to at least 1 reference node;
3 or more blind nodes with more than 1 direct link to the reference nodes;
in the case of only 4 blind nodes with direct links to reference nodes, that the 2 blind nodes with one direct link to a reference node are not linked directly to the same reference node; or
in the case of only 5 blind nodes with direct links to reference nodes, that the 3 blind nodes with only 1 direct link to a reference node are not linked directly to the same reference node.
3.4c) The necessary condition for a rigid body containing one reference node to be locatable is: there are at least 3 reference nodes other than the reference node in the rigid body with at least 4 links to at least 3 blind nodes in the rigid body.
3.4d) A rigid body containing 1 reference node is locatable with probability of 1 if the rule 3.4c) is satisfied, and one of the following conditions is also satisfied
7 or more total links to the 3 reference nodes outside of the rigid body;
5 or more blind nodes with each node linked directly to at least 1 reference node outside of the rigid body;
2 or more blind nodes with more than 1 direct link to reference nodes outside of the rigid body;
in the case of only 3 blind nodes linked directly to the outside reference nodes, that the 2 blind nodes with only one direct link to the outside reference node are not linked directly to the same outside reference node; or
in the case of only 4 blind nodes linked directly to the outside reference nodes, that the 3 blind nodes with only 1 direct link to the outside reference nodes are not linked directly to the same reference node.
3.4e) A rigid body containing 2 reference nodes is locatable with probability of 1 if there are at least 2 reference nodes other than the reference nodes in the rigid body with at least 2 links to at least 2 blind nodes in the rigid body.
3.4f) A rigid body containing 3 reference nodes is locatable with probability of 1 if there is at least 1 reference node other than the reference nodes in the rigid body with at least 1 link to at least 1 blind node in the rigid body.
3.4g) A rigid body containing 4 reference nodes is locatable with probability of 1.

While the preferred embodiments of the invention have been illustrated and described, it will be clear that the invention is not so limited. Numerous modifications, changes, variations, substitutions, and equivalents will occur to those skilled in the art without departing from the spirit and scope of the present invention as defined by the appended claims.

What is claimed is:

1. A method for locating nodes in a multi-hop sensor network, comprising the steps of:
forming at least one rigid body from the nodes of the network;
utilizing the at least one rigid body to decide if a node is locatable;
categorizing all of the nodes by location status;
grouping the nodes into substantially large groups based upon the location status categorizations;
grouping the substantially large groups into sub-groups; and
forming the at least one rigid body from the sub-group of the grouped nodes if the sub-group has at least two nodes.

2. The method for locating nodes according to claim 1, further comprising the steps of:
defining a space with the network; and
defining the at least one rigid body as a non- deformable structure within the space.

3. The method for locating nodes according to claim 1, further comprising the step of:
locating only nodes within the at least one rigid body.

4. The method for locating nodes according to claim 1, further comprising the step of:
making peer-to-peer ranging information of each node available throughout the network.

5. The method for locating nodes according to claim 1, further comprising the step of:
providing the nodes with blind nodes without knowledge of their own location and reference nodes each having a defined location.

6. The method for locating nodes according to claim 1, further comprising the step of:
expanding the at least one rigid body if it is determined that a node or a rigid body is locatable and the at least one rigid body is a reference frame.

7. A method for locating nodes in a multi-hop sensor network for obtaining a reduced order model of the network comprising the steps of:
categorizing all of the nodes by location status;
grouping the nodes into super groups based upon the location status categorizations;
grouping the nodes in each super group into at least one sub-group; and
defining and identifying at least one rigid body from at least one sub-group of each super group if the sub-group has as at least two nodes.

8. The method for locating nodes according to claim 7, further comprising the step of:
utilizing the at least one rigid body to decide whether a node is locatable.

9. The method for locating nodes according to claim 7, further comprising the step of:
identifying a plurality of rigid bodies from at least one sub-group of the grouped nodes.

10. The method for locating nodes according to claim 7, further comprising the steps of:
defining a space with the network; and
defining the at least one rigid body as a non- deformable structure within the space.

11. The method for locating nodes according to claim 7, which further comprises:
locating only nodes within the at least one rigid body.

12. The method for locating nodes according to claim 7, further comprising the step of:
making available peer-to-peer ranging information of each node throughout the network.

13. The method for locating nodes according to claim 7, further comprising the step of:
providing the nodes with blind nodes and a plurality of reference nodes each having a defined location.

14. The method for locating nodes according to claim 7, further comprising the step of:
expanding the at least one rigid body if it is determined that a node or rigid body is locatable and the at least one rigid body is a reference frame.

15. A method for locating nodes in a multi-hop sensor network, comprising the steps of:
categorizing all of the nodes in the network by location status;
grouping the nodes into super groups based upon the location status categorizations;
grouping the nodes in each super group into at least one sub-group; and
simplifying determinability of node location by forming at least one rigid body from each sub-group based upon the categorized location status if the sub-group has at least two nodes.

16. The method for locating nodes according to claim 15, wherein the step of simplifying further comprises the steps of:
separating the nodes into classes including locatable nodes and non-locatable nodes; and
forming at least one rigid body from the locatable nodes.

17. The method for locating nodes according to claim 15, further comprising the step of:
utilizing the at least one rigid body to determine if a node is locatable.

18. The method for locating nodes according to claim 15, further comprising the step of:
forming at least one rigid body from the node categorizations.

19. The method for locating nodes according to claim 15, further comprising the steps of:
defining a space within the network; and
defining the at least one rigid body as a non-deforming structure within the space.

20. The method for locating nodes according to claim 15, further comprising the steps of:
locating only nodes within the at least one rigid body; and
eliminating from further investigation all nodes outside the at least one rigid body.

21. The method for locating nodes according to claim 15, further comprising the step of:
making available peer-to-peer ranging information of each node throughout the network.

22. The method for locating nodes according to claim 15, further comprising the step of:
providing the nodes with blind nodes and at least one reference node having a defined location.

23. The method for locating nodes according to claim 15, further comprising the step of:
expanding the at least one rigid body if it is determined that a node or a rigid body is locatable and the at least one rigid body is a reference frame.
